(19) United States
(12) Patent Application Publication
(10) Pub. No.: US 2021/0249668 A1
(43) Pub. Date: Aug. 12, 2021

(54) SOLID OXIDE FUEL CELL FRAME ASSEMBLY

(71) Applicant: PHILLIPS 66 COMPANY, HOUSTON, TX (US)

(72) Inventors: Mingfei Liu, Bartlesville, OK (US); Ying Liu, Bartlesville, OK (US); Mark J. Jensen, Bartlesville, OK (US)

(73) Assignee: PHILLIPS 66 COMPANY, HOUSTON, TX (US)

(21) Appl. No.: 17/169,750

(22) Filed: Feb. 8, 2021

Related U.S. Application Data
(60) Provisional application No. 62/972,898, filed on Feb. 11, 2020.

(51) Int. Cl. H01M 8/0273; H01M 8/0282

(52) U.S. Cl. CPC H01M 8/0273; H01M 2008/1293; H01M 8/0282

(57) ABSTRACT

A metal frame for sealing a solid oxide fuel cell. The metal frame comprises both a metal top frame positioned on top of a middle frame and a metal bottom frame that is positioned below a middle frame.

### CROSS-REFERENCE TO RELATED APPLICATIONS

This application is a non-provisional application which claims the benefit of and priority to U.S. Provisional Application Ser. No. 62/972,898 filed Feb. 11, 2020, entitled “Solid Oxide Fuel Cell Frame Assembly,” which is hereby incorporated by reference in its entirety.

### STATEMENT REGARDING FEDERALLY SPONSORED RESEARCH OR DEVELOPMENT

None.

### FIELD OF THE INVENTION

This invention relates to a solid oxide fuel cell frame assembly.

### BACKGROUND OF THE INVENTION

Solid oxide fuel cells (SOFC) have been the subject of considerable research in recent years. A typical SOFC comprises an electrolyte layer sandwiched between a cathode layer and an anode layer. In a conventional design, multiple individual fuel cells are arranged in a stack such that gas-tight seals are needed along the edges of each cell on both air and fuel sides. The durability of each seal is often limited due to the high temperatures and the reducing and oxidizing gases present during fuel cell operation.

Solid oxide fuel cells can undergo large thermal cycling and large thermal gradients, inducing thermal stresses in the fuel cell stack components. Seal failure can occur as a result of deterioration, fracture or delamination of a seal material. Such failure can be detrimental, resulting in the loss of electrical current, damage to fuel cell components, and the escape and/or mixing of reactant gases.

Thus, there is a need to address seal failure and other shortcomings associated with conventional seals and methods for sealing SOFCs.

### BRIEF SUMMARY OF THE DISCLOSURE

This embodiment presents a metal frame for sealing a solid oxide fuel cell. The metal frame comprises both a metal top frame positioned on top of a middle frame and a metal bottom frame that is positioned below a middle frame.

In yet another embodiment, a metal frame for sealing a solid oxide fuel cell is described. In this embodiment, a metal frame is positioned above and connected to a top glass seal. The top glass seal is positioned above and connected to a metal middle frame. The metal middle frame is positioned above and connected to a bottom glass seal. The bottom glass seal is positioned above and connected to a metal bottom frame.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts an embodiment of the novel SOFC with metal frame.

FIG. 2 depicts a SOFC sealed on a conventional single-piece frame.

FIG. 3 depicts a SOFC sealed on a tri-layer metal frame assembly

FIG. 4 depicts electrochemical performance of the new SOFC metal frame assembly

FIG. 5 depicts comparative cell performance at 600° C., 650° C., and 700° C.

FIG. 6 depicts cell voltages measured under 200 mA/cm² current at 600° C.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

As briefly introduced above, the present embodiment provides a metal frame for sealing a solid oxide fuel cell (SOFC). The frame comprises both a metal top frame positioned on top of a middle frame and a metal bottom frame that is positioned below a middle frame.

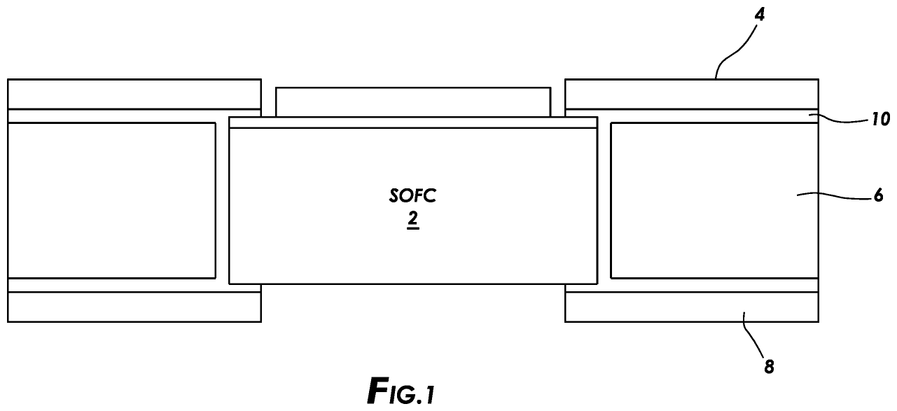

FIG. 1 depicts a side view of the embodiment, wherein the SOFC 2 is enclosed with a tri-layer metal frame to avoid thermal stress. The metal top frame 4 is positioned on top of the middle frame 6, which is positioned on top of the metal bottom frame 8. To avoid direct contact between the metal frame and the SOFC, glass seals 10 can be disposed between the metal top frame and the middle frame, the middle frame and the metal bottom frame, the middle frame and the SOFC, the metal top frame and the SOFC, and the SOFC and the metal bottom frame.

In one embodiment the metal top frame, the middle frame, and the metal bottom frame can be made all out of the same material. In an alternate embodiment, the metal top frame and the metal bottom frame are made out of the same or different material while the middle frame can be made out of a metal different from the metal top frame and the metal bottom frame. In yet another embodiment, the metal top frame and the metal bottom frame are made out of the same or different material while the middle frame can be made out of a non-metallic material.

Non-limiting examples of metal materials that the metal top frame, the metal bottom frame and the middle frame can be made out of include: stainless steels, carbon steels, nickel, copper, brass, superalloys, silver, chromium alloys, molybdenum, and titanium.

Non-limiting examples of non-metal material that the middle frame can be made out of include: metal oxides, metal carbides, metal borides, glass, silicon, and fibers.

The thickness of the metal top frame, the metal bottom frame, and the middle frame can be identical or not identical to each other. In a non-limiting example, the thickness of each frame can range from about 0.1 mm to about 2 mm.

The SOFC that can be used with this novel frame can be any conventionally known SOFC device. Examples of SOFC's that can be made include an anode, electrolyte, or cathode supported planar cell.

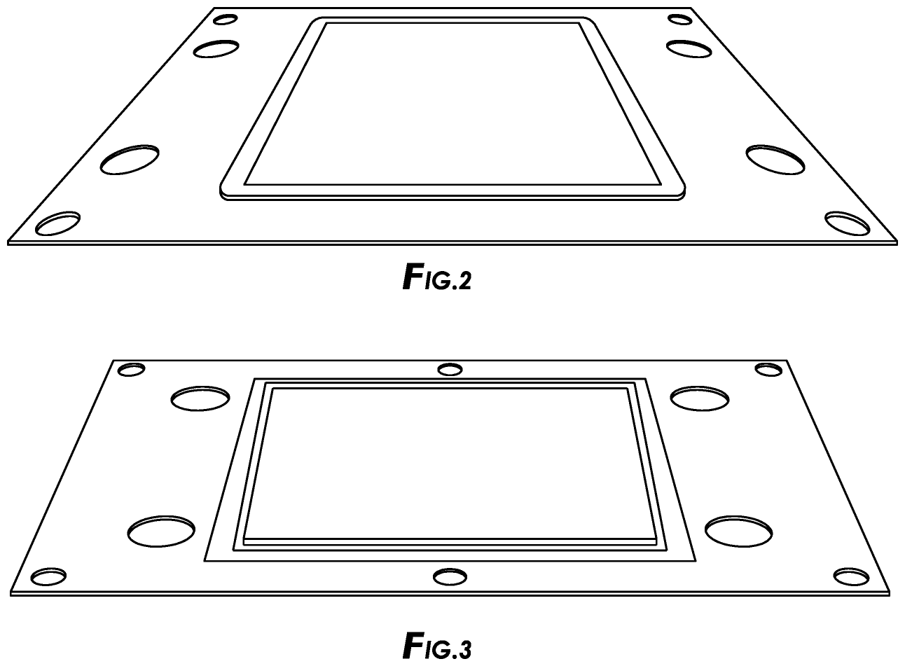

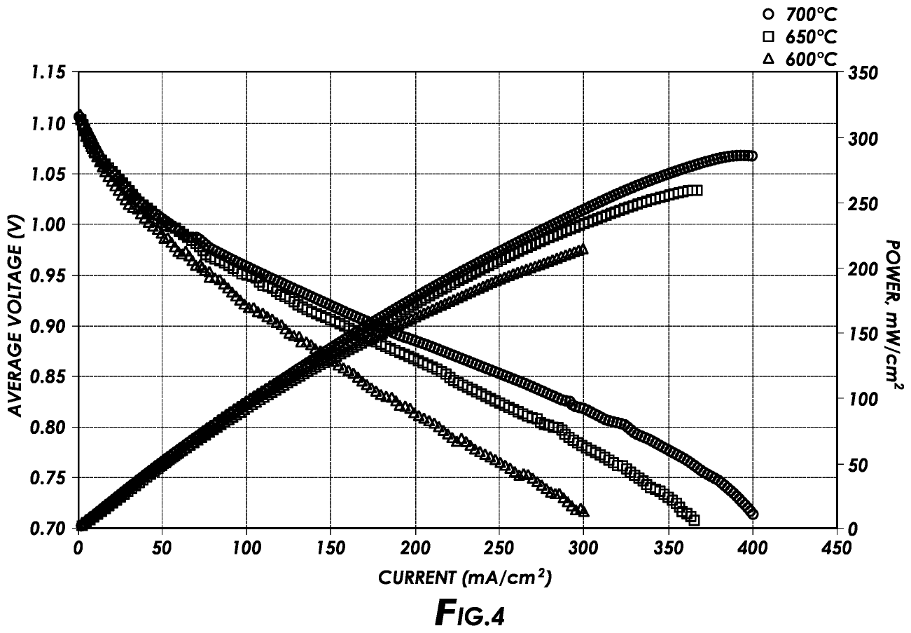

In one non-limiting example, the method of forming the SOFC frame assembly begins by first forming the metal frames, the glass seals and the SOFC. The method then begins by applying the glass seal on the metal bottom frame. The middle frame is then disposed on top of the glass seal of the metal bottom frame. A SOFC is then placed in the center of the middle frame on top of the glass seal and a separate glass seal is applied around the SOFC to ensure that the SOFC is not in direct contact with the middle frame. Another glass seal is then placed on the surface of the middle frame followed by the top metal frame to form a completed cell assembly. This cell assembly is then transferred to a furnace and compressed. The entire assembly is then annealed at a high temperature to achieve a gas tight seal. By forming the cell assembly in such a manner only a single heat cycle/annealing steps is necessary and separate steps to soften the glass seal are not necessary. It is theorized by exposing the cell assembly to only one high temperate heat cycle there will be less curvature and less cell cracking of the SOFC. Shown in FIG. 2 is an SOFC sealed on a conventional single-piece metal frame. Shown in FIG. 3 is another SOFC mounted on a three-layer metal frame. To build the three-layer metal frame assembly, a thin glass coating was applied to a 0.15 mm thick SS430 metal bottom frame by screen-printing and then dried in oven at 90° C. A 0.5 mm thick SS430 middle frame was added on top of the glass coated bottom frame. An SOFC was then placed at the center of the glass coated bottom frame and glass paste was applied between the middle frame and the cell. A thin glass coating was applied to a 0.15 mm thick SS430 metal top frame which was then placed on top. Finally, the cell-frame assembly was annealed at 850° C. for 1 h. The resulting cell-frame assembly was flat and free of thermal stress. In contrast, the SOFC sealed on the conventional single-piece frame structure was significantly curved and the fuel cell was detached from the metal frame at four corners after cooling to room temperature.

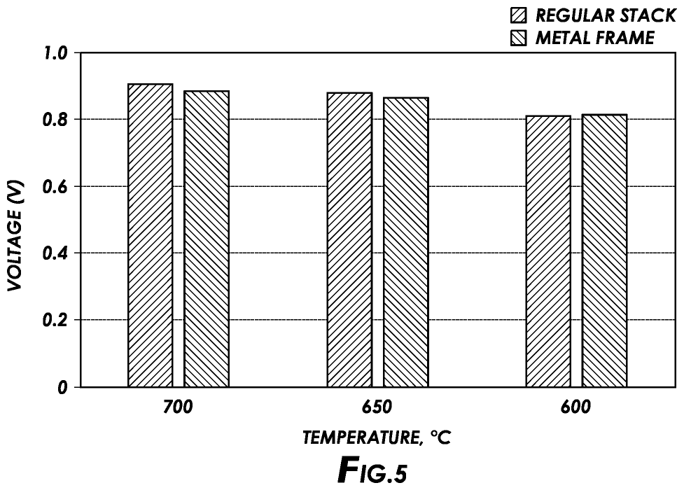

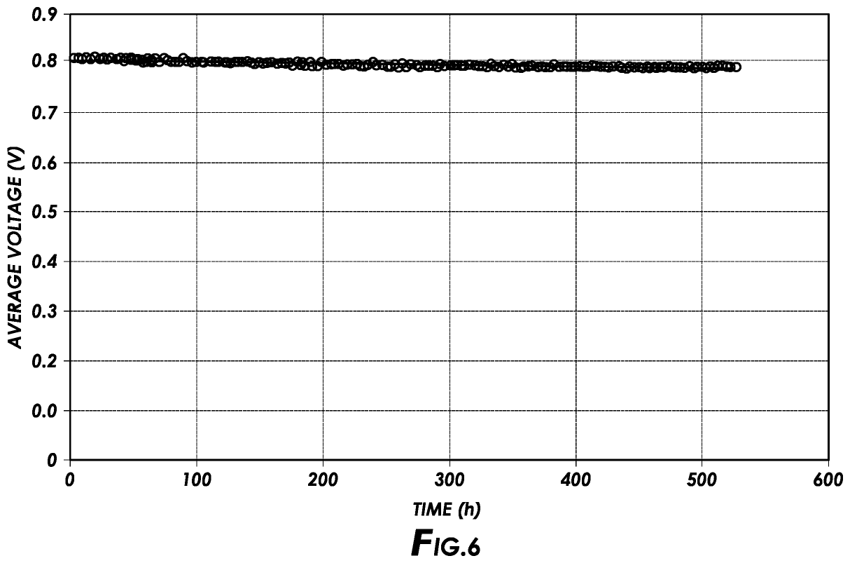

The conventional cell-frame assembly was not able to be tested for electrochemical performance due to the severe gas leakage at the four corners of the cell. The current-voltage and current-power density curves of a short stack containing three metal frame assemblies are shown in FIG. 4. The cells showed excellent performance, i.e., 172, 225, and 259 mW/cm² at 0.8V in hydrogen at 600, 650, and 700° C., respectively as shown in the 3-cell stack test in FIG. 5. In FIG. 6 a cell with the novel metal frame assembly was tested under 200 mA/cm² current at 600° C. This cell assembly ran for over 500 hours and showed less than a 2%/1000 degradation.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A metal frame for sealing solid oxide fuel cells comprising:
a metal top frame positioned on top of a middle frame; and
a metal bottom frame positioned below a middle frame.

2. The metal frame of claim 1, wherein a top glass seal is situated between the metal top frame and the middle frame.

3. The metal frame of claim 1, wherein a bottom glass seal is situated between the metal bottom frame and the middle frame.

4. The metal frame of claim 1, wherein a solid oxide fuel cell is situated below the metal top frame, above the metal bottom frame, and inside the middle frame.

5. The metal frame of claim 4, wherein the thickness of the metal middle frame is identical to the thickness of the middle frame.

6. The metal frame of claim 1, wherein the thickness of the metal top frame ranges from about 0.1 mm to about 2 mm. The metal frame of claim 1, wherein the thickness of the metal bottom frame ranges from about 0.1 mm to about 2 mm.

8. The metal frame of claim 1, wherein the thickness of the middle frame ranges from about 0.1 mm to about 2 mm.

9. The metal frame of claim 1, wherein the metal top frame, the metal middle frame, and the metal bottom frame are brazed together.

10. The metal frame of claim 1, wherein the middle frame is ceramic.

11. The metal frame of claim 1, wherein the middle frame is metal.

12. A metal frame for sealing solid oxide fuel cells comprising:
a metal top frame positioned above and connected to a top glass seal;
the top glass seal positioned above and connected to a metal middle frame;
the metal middle frame positioned above and connected to a bottom glass seal, wherein the metal middle frame has a hole within the center sized to fit a solid oxide fuel cell;
the bottom glass seal positioned above and connected to the metal bottom frame; and
the solid oxide fuel cell positioned below the top glass seal, above the bottom glass seal, and situated within the metal middle frame.
